(19) United States
(12) Patent Application Publication
(10) Pub. No.: US 2013/0001956 A1
(43) Pub. Date: Jan. 3, 2013

(54) SEA WATER ELECTRICAL GENERATOR

(76) Inventor: BRIAN O'NEIL, Half Moon Bay, CA (US)

(21) Appl. No.: 13/240,578

(22) Filed: Sep. 22, 2011

Related U.S. Application Data
(60) Provisional application No. 61/503,295, filed on Jun. 30, 2011.

(51) Int. Cl. H02K 7/18

(52) U.S. Cl. 290/1 A

(57) ABSTRACT

A mechanical/electrical generator system may include a piston ball with an anode and a cathode in the piston ball. A source of DC power may be connected to the anode and cathode. An AC generator may be configured to be rotated through alternating flotation and sinking of the piston ball resulting from electrolysis of salt water.

### RELATED APPLICATIONS

This application claims the benefit of U.S. Provisional Patent Application No. 61503295 filed on Jun. 30, 2011.

### BACKGROUND OF THE INVENTION

The present invention generally relates to systems generating electrical power using sea water. More particularly the invention relates to combining electrolytic gas generation and mechanical motion of flotation devices to generate electrical power.

Electrical power requirements are continually increasing. Many power generating systems that are used to meet these increasing demands depend upon combustion of organic fuels as a source of energy. Combustion of such fuels results in undesirable release of carbon dioxide into the earth's atmosphere.

As can be seen, there is a need for a system of producing and storing electrical power without releasing carbon dioxide into the earth's atmosphere.

### SUMMARY OF THE INVENTION

In one aspect of the present invention, a mechanical/electrical generator system comprising; a piston ball immersible in sea water; an anode and a cathode in the piston ball; a source of DC power connected to the anode and cathode; a cable connecting the piston ball via an anchored pulley to an AC generator; and the AC generator configured to be rotated through alternating flotation and sinking of the piston ball resulting from electrolysis of the sea water.

In another aspect of the present invention, a system for generating electrical power may comprise: an electrolysis reaction chamber submerged in sea water; a plurality of hydrogen collection cups arranged on a conveyor chain so that each cup passes the electrolysis reaction chamber; and a hydrogen collection unit positioned above a surface of the sea water to collect hydrogen from the cups for use in a hydrogen burning electrical generator.

In still another aspect of the invention, a method for generating electrical power may comprise the steps of: filling a piston ball with sea water; submerging the piston ball in sea water while pulling a cable attached to the piston ball; extracting mechanical power from the pulled cable, via an anchored pulley, with an AC generator to produce AC electrical power; and applying DC electrical power to a cathode and electrode in the piston ball to produce gas by electrolysis and to expel the sea water from the piston ball.

These and other features, aspects and advantages of the present invention will become better understood with reference to the following drawings, description and claims.

### BRIEF DESCRIPTION OF THE DRAWINGS

FIG. 1 is a flow chart of a system for generating AC electrical power in accordance with an embodiment of the invention;

FIGS. 2 through 5 are schematic views of operational aspects of an exemplary embodiment of the invention;

FIGS. 6 and 7 are schematic diagrams of operational aspects of an automatic valve in accordance with an exemplary embodiment of the invention;

FIG. 8 is a schematic view of piston ball in accordance with a second embodiment of the present invention; and

FIG. 9 is a schematic view of operational aspects of a third embodiment of the present invention.

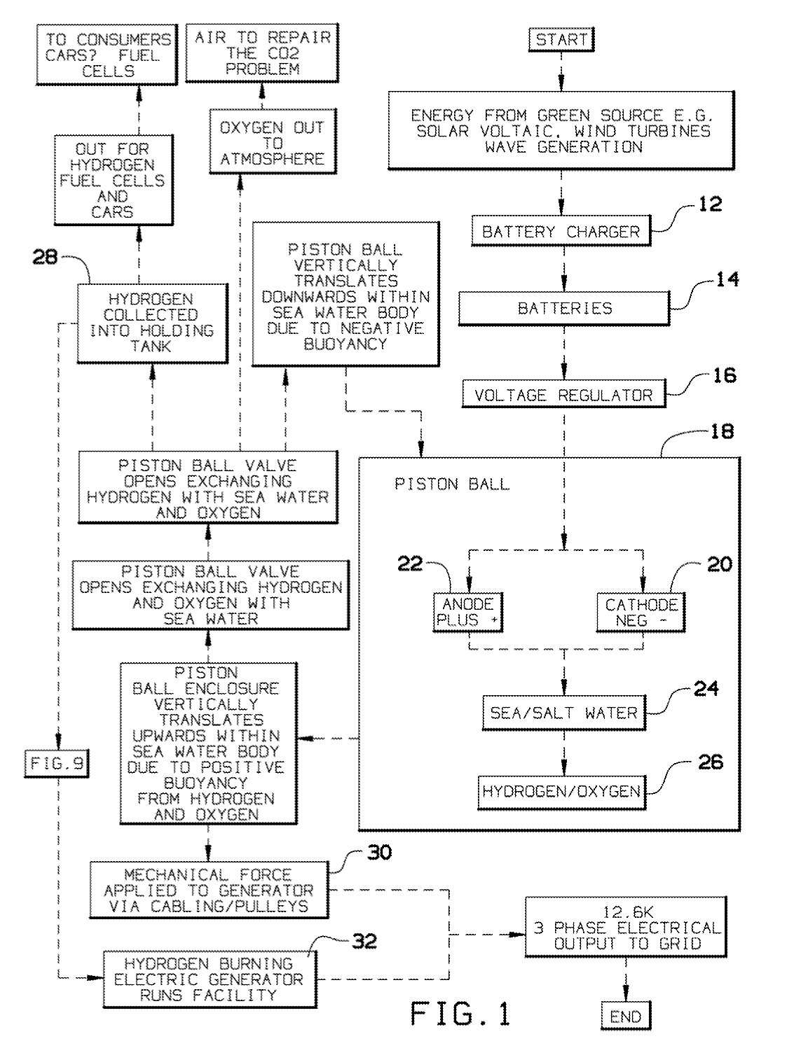

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide electrical generators driven by electrolytic generation of gas and mechanical motion of flotation devices to amplify the total power output from stored energy sources.

Referring to the Figures, it may be seen that an exemplary embodiment of a mechanical/electrical generator system 10 may comprise a battery charger 12, a battery 14, a voltage regulator 16, a piston ball 18, a cathode 20, an anode 22, a 3 phase, high-voltage electrical generator 30, a sea water source 34, a pulley 36 anchored to a bottom, conductive cabling 38 for lift and power, and an automatic valve assembly 40.

In operation, the piston ball 18 may be submerged in sea water 24. Electrical power may be applied to the cathode 20 and anode 22 through the cable 38. The electrical power may be provided from a green energy source (not shown) such as solar cells, or wind turbines and may be delivered to the cable 38 through the battery charger 12, the batteries 14 and the voltage regulator 16. The electrical power may cause the cathode 20 and anode 22 to produce an electrolytic separation of the sea water 24 into a gaseous mixture 26 of hydrogen and oxygen. As the gas mixture 26 is produced in the ball 18, it may displace the sea water 24 from inside the ball 18 through openings 58. As the sea water 24 is displaced, buoyancy of the ball 18 may increase and the ball 18 may begin to rise.

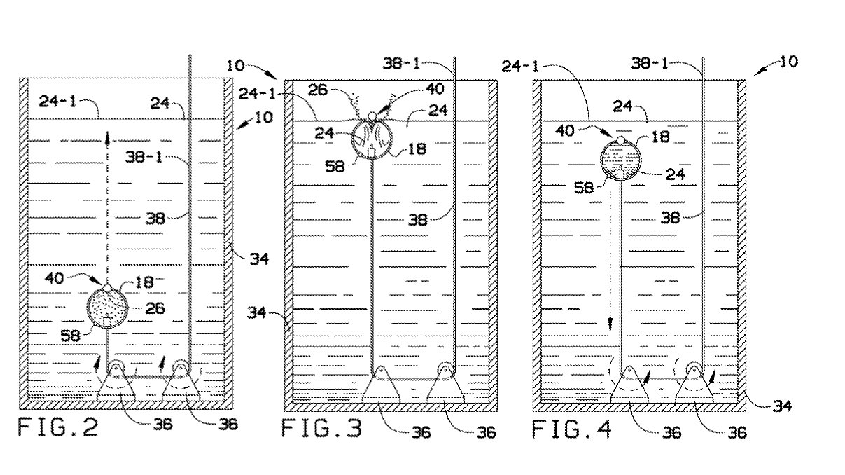

As the ball 18 rises (See FIG. 2), an upper portion 38-1 of the the cable 38 may be pulled downwardly around the pulleys 36. This downward motion of the cable 38 may be translated into rotational motion of the generator 30 (see FIG. 5) thereby producing 3 phase electrical power.

The ball 18 may continue to rise until it reaches a surface 24-1 of the sea water 24. At this point, the automatic valve assembly 40 may release the gas mixture 26 from the ball 18 (see FIG. 3). After the gas mixture 26 is released, sea water 24 may re-enter the ball 18 through the openings 58. The buoyancy of the ball 18 may decrease and the ball 18 may sink into the sea water 24 (see FIG. 4).

As the ball 18 sinks, the upper portion 38-1 of the cable 38 may be pulled upwardly around the pulleys 36. This upward motion of the cable 38 may be translated into rotational motion of the generator 30 (see FIG. 5) thereby producing 3 phase electrical power. The generator 30 may be provided with a clutch and gear power input system (not shown) which may produce a rotational motion in one direction irrespective of whether the cable 38 is moving up or down.

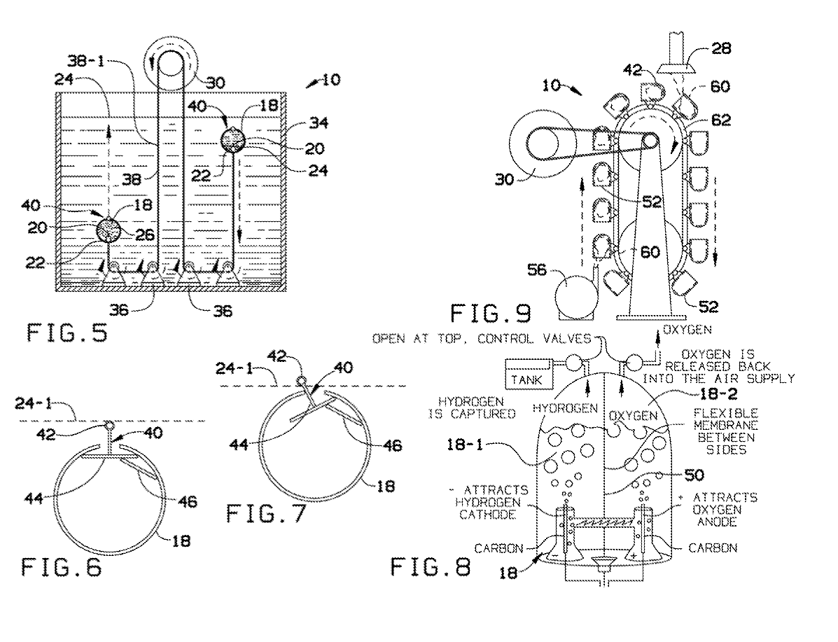

Referring now to FIGS. 6 and 7, it may be seen that an exemplary embodiment of the automatic valve 40 may comprise a flotation ball 42, a sealing member 44 and a spring 46. The spring 46 may be attached to the sealing member 44 and the inner surface of the piston ball 18. The spring 46 may have a spring force less than a buoyancy force of the flotation member 42.

When the ball 18 is below the surface 24-1 of sea water 24, the flotation ball 42 may exert an upward force to hold the sealing member 44 against an inner surface of the ball 18. When the ball 18 rises to a position near the surface 24-1, the flotation ball 42 may no longer exert upward force on the sealing member 44. The spring 46 and gravity may pull the sealing member away from the inner surface of the ball 18, thus releasing gas 26 from the ball 18.

In an alternate embodiment of the invention shown in FIG. 8, the ball 18 may be constructed with a membrane 50 separating a hydrogen chamber 18-1 from an oxygen chamber 18-2. The cathode 20 may be positioned in the hydrogen chamber 18-1 and the anode may be positioned in the oxygen chamber 18-2. When the ball 18 reaches the surface 24-1 (see FIG. 3), the hydrogen may be released separately from oxygen.

In still another embodiment of the invention shown in FIG. 9, a series of cups 52 may be arranged to be transported past an electrolysis reaction chamber 56 on a conveyor chain 62. The chamber 56 and a portion of the chain 48 may be immersed in sea water. Hydrogen 60 may enter the cups 52 as they pass the chamber 56. Hydrogen 60 may then be transported to a collection unit 28 for delivery to a hydrogen burning generator (not shown). The generator 30 may also be driven be flotation action of the cups 52.

It should be understood, of course, that the foregoing relates to exemplary embodiments of the invention and that modifications may be made without departing from the spirit and scope of the invention as set forth in the following claims.

What is claimed is:

1. A mechanical/electrical generator system comprising;
a piston ball immersible in sea water;
an anode and a cathode in the piston ball;
a source of DC power connected to the anode and cathode;
a cable connecting the piston ball, via an anchored pulley, to an AC generator; and
the AC generator configured to be rotated through alternating flotation and sinking of the piston ball resulting from electrolysis of the sea water.

2. The system of claim 1 wherein the piston ball comprises an automatic gas release valve.

3. The system of claim 2 herein the automatic gas release valve comprises:
a flotation member
a sealing member attached to the flotation member and configured to seal against an inner surface of the piston ball; and
a spring attached to the sealing member and the inner surface of the piston ball, then spring having a spring force less than a buoyancy force of the flotation member.

4. The system of claim 1 wherein the piston ball comprises a hydrogen holding chamber and a oxygen holding chamber, the two chambers being separated by a membrane.

5. A system for generating electrical power comprising;
an electrolysis reaction chamber submerged in sea water;
a plurality of hydrogen collection cups arranged on a conveyor chain so that each cup passes the electrolysis reaction chamber; and
a hydrogen collection unit positioned above a surface of the sea water to collect hydrogen from the cups for use in a hydrogen burning electrical generator.

6. The system of claim 5 further comprising an AC generator coupled to be driven by motion of the conveyor chain produced by buoyancy of the cups in the sea water.

7. A method for generating electrical power comprising the steps of:
filling a piston ball with sea water;
submerging the piston ball in sea water while pulling a cable attached to the piston ball;
extracting mechanical power from the pulled cable with an AC generator to produce AC electrical power;
applying DC electrical power to a cathode and electrode in the piston ball to produce gas by electrolysis and to expel the sea water from the piston ball.

8. The method of claim 7 further comprising the step of extracting mechanical power from the pulled cable with an AC generator to produce AC electrical power as the piston ball rises after the sea water is expelled.

9. The method of claim 7 wherein the DC electrical power is produced from a green power source.

10. The method of claim 7 further comprising the step of:
collecting hydrogen produced by electrolysis; and
burning the collected hydrogen to produce energy to drive an AC electrical generator.
